(19) United States
(12) Patent Application Publication
(10) Pub. No.: US 2020/0182331 A1
(43) Pub. Date: Jun. 11, 2020

(54) GEAR TRANSMISSION DEVICE

(71) Applicant: AISIN SEIKI KABUSHIKI KAISHA, Kariya-shi, Aichi-ken (JP)

(72) Inventor: Katsuhiro TSUJIMOTO, Toyota-shi, Aichi-ken (JP)

(73) Assignee: AISIN SEIKI KABUSHIKI KAISHA, Kariya-shi, Aichi-ken (JP)

(21) Appl. No.: 16/479,794

(22) PCT Filed: Aug. 31, 2017
(86) PCT No.: PCT/JP2017/031426

§ 371 Date: Jul. 22, 2019

(30) Foreign Application Priority Data
Mar. 28, 2017 (JP) 2017-062864

(51) Int. Cl. F16H 1/10; F16H 55/08; F16H 55/17; F01L 1/352

(52) U.S. Cl. CPC F16H 1/10; F01L 1/352; F16H 55/17; F16H 55/08

(57) ABSTRACT

Provided is a gear transmission device that can suppress backlash favorably even in the case of extended use. The gear transmission device includes a first gear having a plurality of first tooth portions with a tooth thickness that increases progressively toward the outer end side, a second gear having a plurality of second tooth portions with a tooth thickness that decreases progressively toward the outer end side, and an urging portion configured to apply an urging force to the first gear in the direction along the rational axis in such a manner that the tooth surface of the first tapered tooth area is placed in abutment against the tooth surface of the second tapered tooth area.

### TECHNICAL FIELD

The present invention relates to a gear transmission device configured to suppress backlash phenomenon.

### BACKGROUND ART

Patent Document 1 discloses a technique of a gear transmission device wherein a pivot gear rotatably supported to a tilted shaft portion tilted relative to an input shaft portion, a fixed gear and an output gear coupled to an output shaft portion are arranged coaxially so as to obtain a large speed reduction through rotation of the input shaft portion.

With this Patent Document 1, the pivot gear is configured as a ring-shaped member having tooth portions thereof at opposed terminal edges thereof in the axial direction, and similar tooth portions are formed in the fixed gear so as to mesh with these teeth portions. And, similar tooth portions are formed also in the output gear. Differences of number of teeth are set for/among the pivot gear, the fixed gear and the output shaft portion. In operation, in association with driving rotation of the input shaft portion, one-side tooth portion of the pivot gear meshes with the tooth portions of the fixed gear one after another and simultaneously therewith the other tooth portion of the pivot gear meshes with the tooth portions of the output gear one after another. With this operation, there is provided a mode of transmission in which during one rotation of the input shaft portion, the output shaft portion is rotated by an angle corresponding to the tooth number difference, thus realizing a large speed reduction.

In particular, this Patent Document 1 describes that an appropriate preload is applied to the meshing of gears in order to reduce backlash.

Further, Patent Document 2 discloses a technique wherein an internal type gear (a ring gear in this document) is disposed coaxial with a rotation axis and an external type gear (an inner gear in this document) is disposed coaxial with an eccentric axis arranged parallel with the rotation axis, and an eccentric member (an eccentric ring in the document) supporting the external type gear rotatably about the eccentric axis is provided.

According to this Patent Document 2, a spring member is provided for urging the external type gear to protrude toward the eccentric direction for maintaining meshing of the tooth portion of the external type gear with the tooth portion of the internal type gear, thus suppressing generation of hitting noise due to backlash.

Still further, Patent Document 3 discloses a technique wherein a tooth portion of one gear of pared gears is provided with a shape, different from the tooth shape of a standard gear, having an abutment stepped portion extending in a tapered manner, and meshing this gear with the other gear (the standard tooth shape gear) may suppress backlash.

In this Patent Document 3, a restriction member is provided since a position displacement due to a force generated in the thrust direction at the meshing position of the gears is invited.

### DOCUMENT OF PRIOR ART

### Patent Documents

Patent Document 1: Japanese Unexamined Patent Application No. 2016-128708 Publication Document

Patent Document 2: Japanese Unexamined Patent Application No. 2016-44627 Publication Document

Patent Document 3: Japanese Unexamined Patent Application No. 2007-309433 Publication Document

### OVERVIEW OF THE INVENTION

### Problems to be Solved by Invention

With a gear transmission device, as disclosed in Patent Documents 1 and 2, it is generally implemented to apply an urging force of a spring or the like in the tooth height direction in order to maintain meshing of tooth portions. However, even with such arrangement of applying an urging force, backlash can sometimes increase due to temporal (aging) change or wear of the tooth surface.

Especially, in the case of the arrangements disclosed in Patent Documents 1 and 2 in which the number of teeth is increased in order to obtain a large speed reduction ratio, the tooth height is decreased and wear of the tooth surface will tend to lead to increase of backlash.

In view of such inconvenience as above, the arrangement disclosed in Patent Document 3 can suppress backlash associated with wear of the tooth surface more easily than the arrangements disclosed in Patent Documents 1 and 2, yet it is imaginable also that backlash may increase with progress of the wear of the tooth surface.

For such reasons as described above, there is a need for a gear transmission device that can suppress backlash favorably even in the case of extended use.

### Solution

For accomplishing the above-noted object, according to a characterizing feature of a gear transmission device relating to the present invention, the gear transmission device comprises:

a first gear having a plurality of first tooth portions, each of which forms a first tapered tooth area having a spur tooth area on one end side in a tooth width direction and having, on the other side in the tooth width direction, a tooth thickness that increases progressively toward the outer end side;

a second gear disposed coaxially with a second rotational axis parallel with a first rotational axis of the first gear, the second gear having a plurality of second tooth portions, each of which forms a second tapered tooth area having a spur tooth area on one end side in a tooth width direction and having, on the other side in the tooth width direction, a tooth thickness that decreases progressively toward the outer end side; and

an urging portion configured to apply an urging force in a thrust direction to either one of the first gear and the second gear in such a manner that the first tapered tooth area of the first gear and the second tapered tooth area of the second gear come into abutment against each other with the spur tooth area of the second gear meshing with the spur tooth area of the first gear.

With this characterizing arrangement, by meshing the spur tooth area of the second tooth portion with the first tooth portion and applying an urging force from the urging portion in the thrust direction, the first tapered tooth area and the second tapered area may be brought into abutment against each other. Therefore, if wear occurs even in one of the first tooth portion and the second tooth portion, a mutual displacement occurs in the thrust direction between the first gear and the second gear in such a manner that the first tapered area and the second tapered area may engage into each other to fill the gap created by this wear. Namely, irrespectively of degree of wear developed in the first tooth portion and the second tooth portion, no gap will be formed between the first tapered tooth area of the first tooth portion and the second tapered tooth area of the second tooth portion, thus suppressing increase of the backlash. Moreover, when a torque is to be transmitted between the first gear and the second gear, the first gear and the second gear will be displaced slightly in the thrust direction in the mutually separating direction for creating an appropriate amount of backlash, whereby smooth operation is made possible.

Consequently, it is possible to configure a gear transmission device that can suppress backlash favorably even in the case of extended use.

According to a further characterizing feature, preferably, at least one of the spur tooth area of the first gear and the spur tooth area of the second gear has a tooth width exceeding a half of the tooth width of each gear.

With the above-described arrangement, even if the first gear and the second gear are displaced significantly away from each other against the urging force of the urging portion, in the case of e.g. load increase, the spur tooth area of the first tooth portion and the spur tooth area of the second tooth portion may come into contact with each other, so that the torque transmission is made possible therebetween.

According to a still further characterizing feature, preferably, one of the first gear and the second gear is an internal gear having a plurality of internal tooth portions in an inner circumference of an annular body, and the other thereof is an external gear having a plurality of external tooth portions formed in an outer circumference of a cylindrical body to mesh with the internal tooth portions of the internal gear.

With the above-described arrangement, it becomes possible to transmit a rotational force between the internal gear and the external gear. Even when an internal contact type planetary gear speed reduction device is employed in a driving system from which precision operations are required, such as a robot hand, as an example of the above-described arrangement, backlash can be suppressed, so such precision operations required of a robot hand are made possible.

According to a still further characterizing arrangement, preferably, at least one of a tilt angle formed by the tooth surface of the first tapered tooth area relative to the first rotational axis and a tilt angle formed by the tooth surface of the second tapered tooth area relative to the second rotational axis is less than 30 degrees.

With the above-described arrangement, since the angle less than 30 degrees is a gentle tilt angle, if at least one of the tilt angles is formed less than 30 degrees, it is possible for the urging force of the urging portion to maintain the meshed state between the first tapered tooth area and the second tapered tooth area.

### DESCRIPTION OF THE DRAWINGS

FIG. 1 is a section view of a valve opening/closing timing control device,

FIG. 2 is a section view taken along a line II-II in FIG. 1,

FIG. 3 is a section view taken along a line III-Ill in FIG. 1,

FIG. 4 is an exploded perspective view showing an output gear, an input gear and an eccentric member,

FIG. 5 is a section view showing a meshing portion between the output gear and the input gear, and

FIG. 6 is a perspective view showing a gear transmission device relating to a further embodiment (a).

### MODES FOR CARRYING OUT THE INVENTION

Next, embodiments of the present invention will be described with reference to the accompanying drawings.

[Basic Configuration]

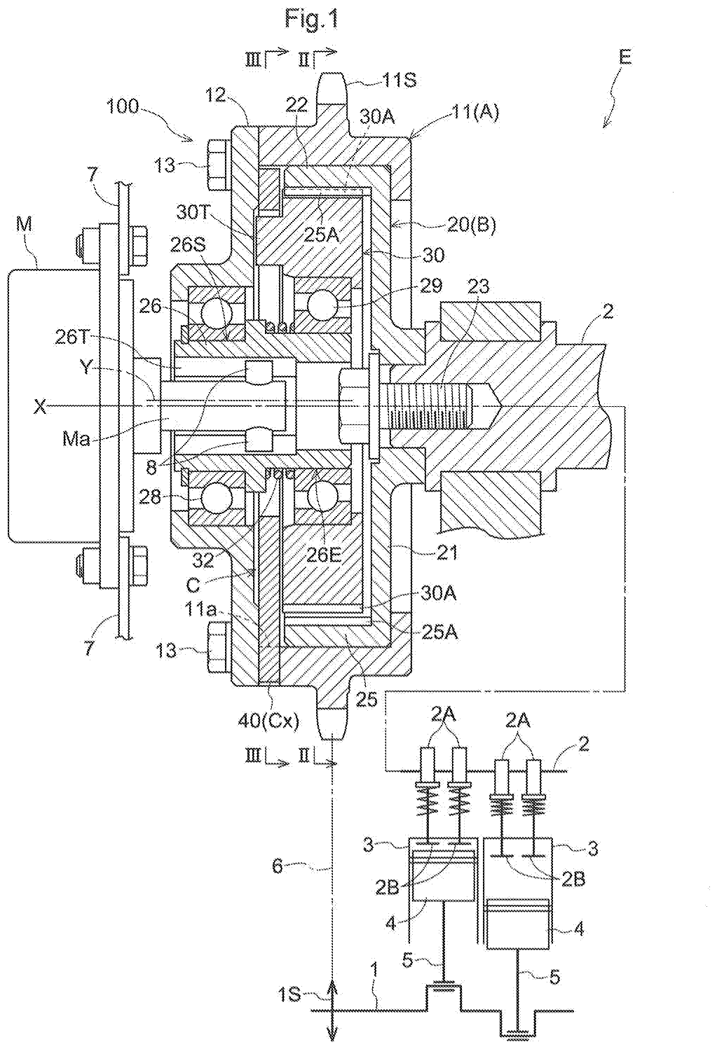

As shown in FIG. 1, a valve opening/closing timing control device 100 includes a driving rotary body A rotatable in synchronism with a crankshaft 1 of an engine E, a driven rotary body B rotatable together with an intake cam shaft 2 about a rotational axis X, and a phase adjustment portion C having a gear transmission mechanism to set a relative rotational phase between the driving rotary body A and the driven rotary body B by a driving force of a phase control motor M.

The engine E is configured as a four-cycle type in which pistons 4 are accommodated in a plurality of cylinders 3 formed in a cylinder block and these pistons 4 are connected via connecting rods 5 to a crankshaft 1. A timing chain 6 (this can be a timing belt or the like also) is wound around and between an output sprocket 1S of the crankshaft 1 of this engine E and a driving sprocket 11S of the driving rotary body A.

With the above-described arrangement in operation, during an operation of the engine E, the entire valve opening/closing timing control device 100 will be rotated about the rotational axis X. Further, with driving of the phase control motor M, there is realized displacement of the relative rotational phase in which the phase adjustment portion C displaces the driven rotary body B relative to the driving rotary body A in a same rotational direction or an opposite direction (this mode of operation will be described in details later). With this displacement of the relative rotational phase, control of the opening/closing timing of an intake value 2B by a cam portion 2A of an intake cam shaft 2 is realized.

Incidentally, an operation of displacement of the driven rotary body B in the same rotational direction as the rotational direction of the driving rotary body A will be referred to as the advance operation. By this advance operation, the intake compression ratio is increased. Also, an operation of displacement of the driven rotary body B in the opposite direction (the direction opposite to the above-described direction) to the rotational direction of the driving rotary body A will be referred to as the retard operation. By this retard operation, the intake compression ratio is decreased.

[Valve Opening/Closing Timing Control Device]

As shown in FIG. 1, the driving rotary body A includes an outer case 11 forming a driving sprocket 11S in its outer circumference, and a front plate 12 fastened to the outer case 11 via a plurality of fastener bolts 13. The outer case 11 is a bottomed cylinder type having an opening at its bottom.

In an inner space of the outer case 11, there are accommodated an intermediate member 20 as the driven rotary body B and the phase adjustment portion C having the gear transmission device.

The intermediate member 20 constituting the driven rotary body B includes a support wall portion 21 coupled to the intake cam shaft 2 under a posture perpendicular to the rotational axis X and a cylindrical wall portion 22 in the form of a cylinder centering about the rotational axis X and protruding in a direction away from the intake cam shaft 2, with the support wall portion 21 and the cylindrical wall portion 22 being formed integral with each other.

In this intermediate member 20, an outer circumferential face of the cylindrical wall portion 22 is rotatably fitted into contact with an inner circumferential face of the outer case 11 and the intermediate member 20 is fixed to an end portion of the intake cam shaft 2 with a connecting bolt 23 inserted through a through hole provided at the center of the support wall portion 21.

The phase control motor M (an electric motor) is supported to the engine E via a support frame 7 in such a manner that its output shaft Ma is disposed on the same axis as the rotational axis X. On the output shaft Ma, there are provided a pair of engagement pins 8 under a posture perpendicular to the rotational axis X.

[Phase Adjustment Portion]

As shown in FIG. 1, the phase adjustment portion C includes the intermediate member 20, an output gear 25 (an example of a “second gear”) formed in the inner circumferential face of the cylindrical wall portion 22 of the intermediate member 20, an eccentric member 26, a first bearing 28, a second bearing 29, an input gear 30 (an example of a “first gear”), a compression coil type spring 32 acting as an “urging portion” and an Oldham's shaft coupling Cx.

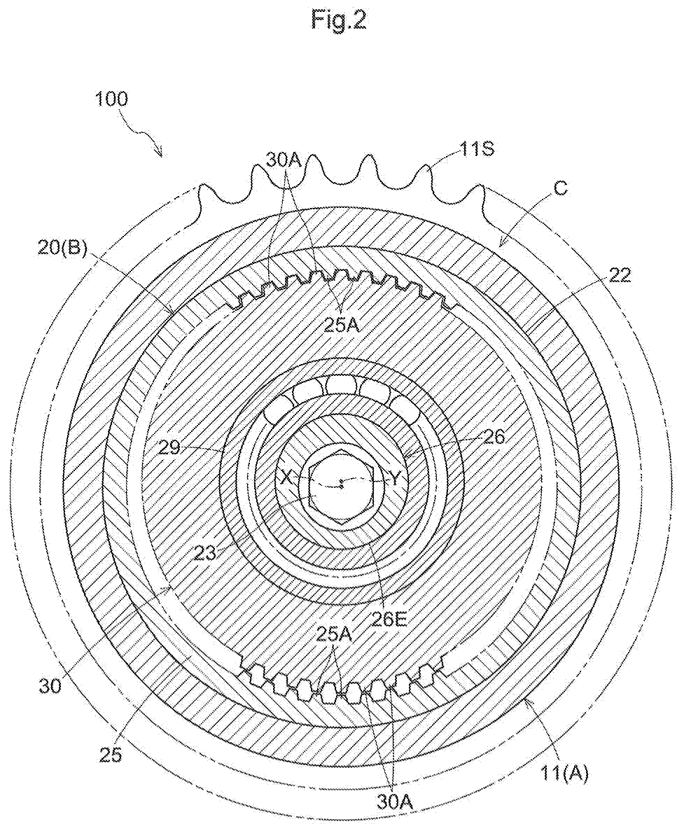

As shown in FIGS. 1 and 2, the output gear 25 is configured as an internal gear having a plurality of internal tooth portions 25A (an example of “second tooth portion(s)”) formed in the inner circumference of an annular body centering about the rotational axis X. The input gear 30 is configured as an external gear having a plurality of external tooth portions 30A (an example of “first tooth portion(s)”) formed in the outer circumference of a cylindrical body centering about an eccentric axis Y.

With this phase adjustment portion C, the number of teeth of the external tooth portions 30A of the input gear 30 is 1 (one) fewer than the number of teeth of the internal tooth portions 25A of the output gear 25. And, in this phase adjustment portion C, as will be described later, since the input gear 30 is supported to be rotatable about the eccentric axis Y, a portion of the external tooth portion 30A is meshed with a portion of the internal tooth portion 25A of the output gear 25.

In the eccentric member 26, there is formed a center bearing face 26S on the outer end side (the side away from the intake cam shaft 2) in the direction along the rotational axis X and centering about the rotational axis X. Further, in this eccentric member 26, there is formed an eccentric bearing face 26E on the inner end side (the side close to the intake cam shaft 2) in the outer circumferential face about the eccentric axis Y and under a posture parallel with the rotational axis X.

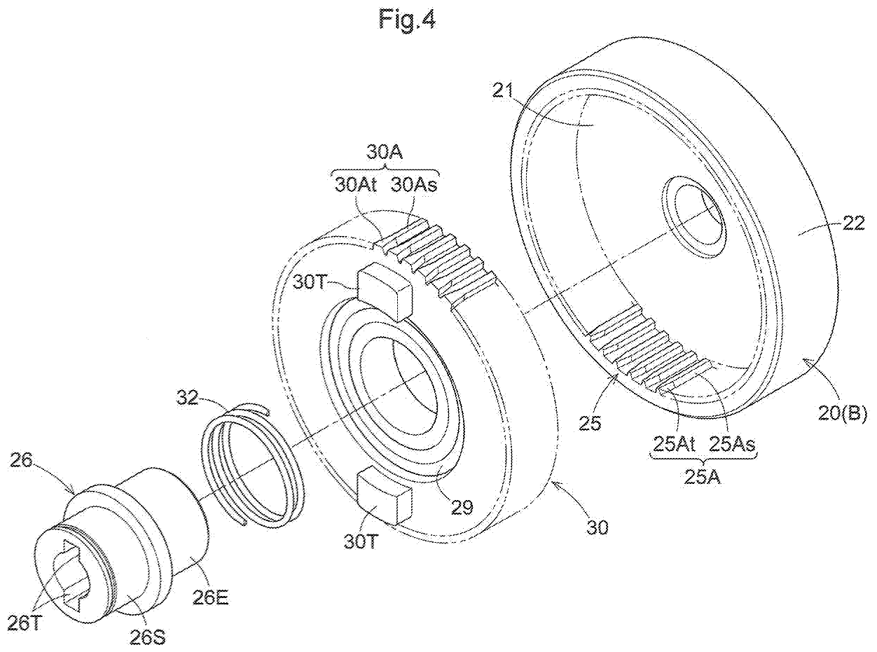

As shown in FIG. 1 and FIG. 4, in the inner circumference of the eccentric member 26, a pair of engagement grooves 26T capable of engaging with the pair of respective engagement pins 8 of the phase control motor M (see FIG. 1) are formed under a posture parallel with the rotational axis X.

As shown in FIG. 1, as the first bearing 28 and the second bearing 29, ball bearings are employed. And, the inner circumference (inner race) of the first bearing 28 is fitted on the center bearing face 26S. Further, the outer circumference (outer race) of this first bearing 28 is fitted within a retention space formed at the center portion of the front plate 12. In this way, the eccentric member 26 is supported to be rotatable about the rotational axis X. In this valve opening/closing timing control device 100, as the first bearing 28 and the second bearing 29, bushes can be employed also.

Moreover, as shown in FIG. 2, the inner circumference (inner race) of the second bearing 29 is fitted on the eccentric bearing face 26E and the outer circumference (outer race) of this second bearing 29 is fitted in the inner circumference of the input gear 30. With this, the input gear 30 is supported to be rotatable about the eccentric axis Y. In this way, as a result of the input gear 30 being disposed at an eccentric position, a portion of the external tooth portion 30A of the input gear 30 is meshed with a portion of the internal tooth portion 25A of the output gear 25.

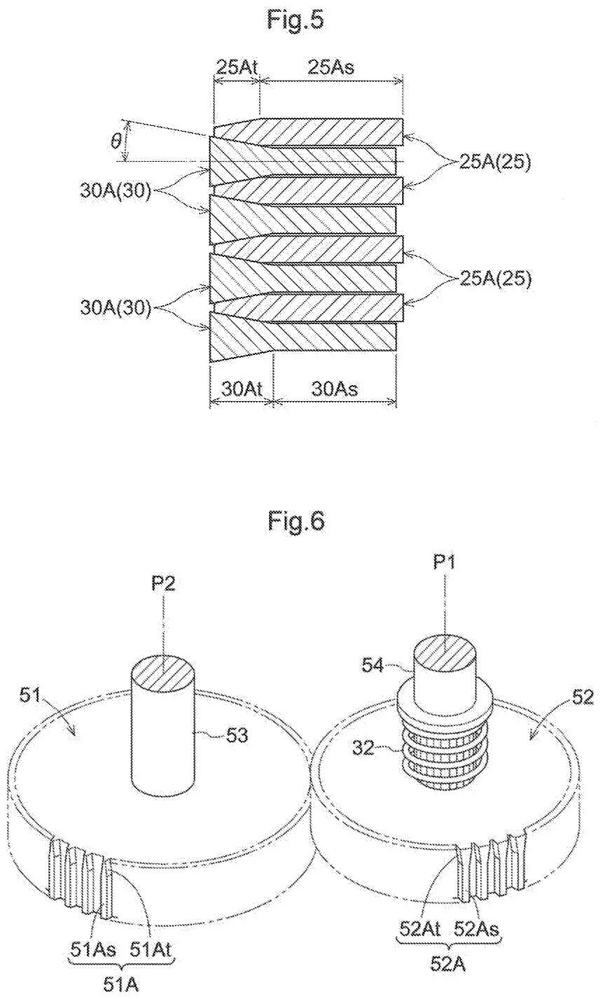

As shown in FIG. 4 and FIG. 5, the internal tooth portion 25A of the output gear 25 (an example of the “second gear”) includes a second spur tooth area 25As provided on the inner end side (the side close to the intake cam shaft 2) and parallel with the rotational axis X and a second tapered tooth area 25At provided on the outer end side (the side away from the intake cam shaft 2) and having a tooth thickness (the vertical direction in the FIG. 5 illustration) that progressively decreases toward the outer end side, with the second spur tooth area 25As and the second tapered tooth area 25At being formed integral with each other.

On the other hand, the external tooth portion 30A of the input gear 30 (an example of the “first gear”) includes a first spur tooth area 30As provided on the inner end side (the side close to the intake cam shaft 2) and parallel with the eccentric axis Y and a first tapered tooth area 30At provided on the outer end side (the side away from the intake cam shaft 2) and having a tooth thickness that progressively increases toward the outer end side, with the first spur tooth area 30As and the first tapered tooth area 30At being formed integral with each other.

Incidentally, the first spur tooth area 30As and the second spur tooth area 25As respectively is formed at an area exceeding 50% of the size in the tooth width direction (the left/right direction in the case of FIG. 5 illustration). And, as shown in FIG. 5, the first tapered tooth area 30At and the second tapered tooth area 25At are formed symmetrical relative to the center of tooth thickness. Moreover, tilt angles (θ) (angles similar to twist angles) of tooth surfaces of the first tapered tooth area 30At and the second tapered tooth area 25At relative to the rotational axis X are set respectively to less than 30 degrees.

Further, the urging force of the spring 32 is caused to be applied in the direction for shifting the external tooth portions 30A of the input gear 30 in the direction (thrust direction) along the rotational axis X relative to the internal tooth portions 25A of the output gear 25. As a specific arrangement, the spring 32 is provided to be fitted on the eccentric bearing face 26E of the eccentric member 26 and as an urging force of this spring 32 is caused to act on the inner race of the second bearing 29, a shifting force is applied to the input gear 30. Incidentally, in the instant embodiment, the compression coil type spring 32 is employed as the “urging portion”. However, this urging portion may be a disc spring also.

[Phase Adjustment Portion: Oldham's Shaft Coupling]

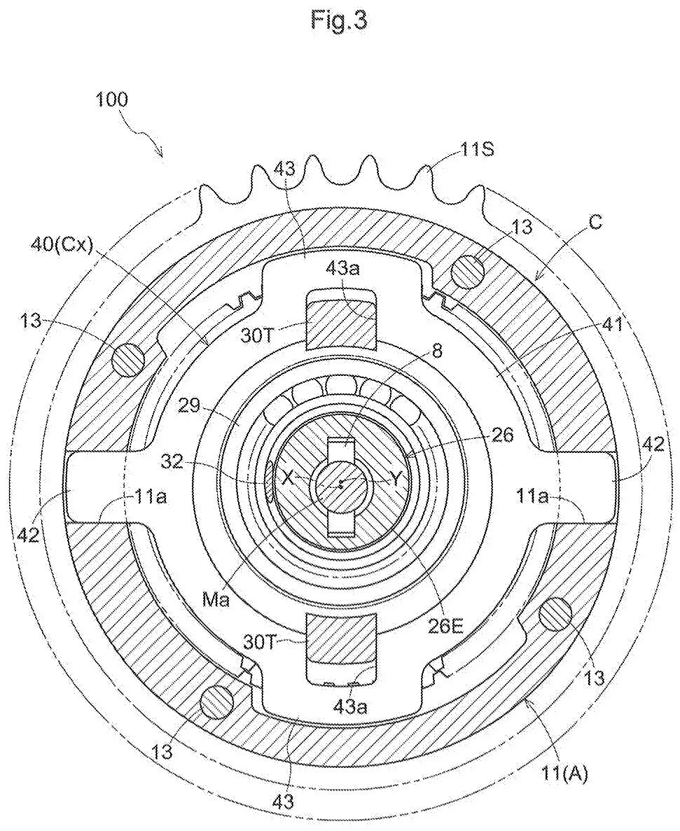

As shown in FIG. 3, the Oldham's shaft coupling Cx is constituted of a plate-like coupling member 40 including a center annular portion 41, a pair of external engagement arms 42 protruding radially outwards from the annular portion 41 along a first direction (the left/right direction in FIG. 3 illustration), and a pair of internal engagement arms 43 protruding radially outwards from the annular portion 41 along the direction (the vertical direction in the FIG. 3 illustration) perpendicular to the first direction, with the center annular portion 41, the external engagement arms 42 and the internal engagement arms 43 being formed integral with each other. Each one of the pair of internal engagement arms 43 forms an engagement recess 43a continuous with the opening of the annular portion 41.

As shown in FIG. 1, in the outer case 11, an opening edge portion thereof placed in abutment against the front plate 12, there are formed, in the form of through grooves, a pair of guide groove portions 11a extending from the inner space of the outer case 11 to the outside space and extending in the radial direction about the rotational axis X. As shown in FIG. 3, the groove width of this guide groove portion 11a is set slightly greater than the width of the external engagement arm 42.

Further, as shown in FIG. 1, in the input gear 30, at an end face thereof opposed to the front plate 12, there are formed a pair of engagement protrusions 30T. As shown in FIG. 3, the engagement width of this engagement protrusion 30T is set slightly narrower than the engagement width of the engagement recess 43a of the internal engagement arm 43.

Incidentally, as shown in FIG. 3, the coupling member 40 is displaceable relative to the outer case 11 (see FIG. 1) in the first direction (the left/right direction in FIG. 3 illustration) along which the external engagement arms 42 extend. Further, relative to this coupling member 40, the input gear 30 is displaceable in the second direction (the vertical direction in FIG. 3 illustration) along the forming direction of the engagement recesses 43a of the internal engagement arms 43.

[Layout of Respective Parts of Valve Opening/Closing Timing Control Device]

In the valve opening/closing timing control device 100 under its assembled state, as shown in FIG. 1, the support wall portion 21 of the intermediate member 20 is coupled via the connecting bolts 23 to the end portion of the intake cam shaft 2, so that these parts are rotated together. The eccentric member 26 is supported via the first bearing 28 to be rotatable about the rotational axis X relative to the front plate 12.

As shown in FIG. 1 and FIG. 3, the input gear 30 is supported via the second bearing 29 to the eccentric bearing face 26E of the eccentric member 26. With this, the input gear 30 is supported to be rotatable about the eccentric axis Y and also a portion of the external tooth portion 30A is meshed with a portion of the internal tooth portion 25A of the output gear 25.

Further, as shown in FIG. 3, the external engagement arms 42 of the Oldham's shaft coupling Cx are engaged with the pair of guide groove portions 11a of the outer case 11 and the engagement protrusions 30T of the input gear 30 are engaged in the engagement recesses 43a of the internal engagement arms 43 of the Oldham's shaft coupling Cx.

Further, as shown in FIG. 1, the pair of engagement pins 8 formed on the output shaft Ma of the phase control motor M are engaged in the engagement grooves 26T of the eccentric member 26.

The urging force of the spring 32 acts on the input gear 30 as a whole in the direction (thrust direction) along the rotational axis X. Therefore, at the area where a portion of the external tooth portion 30A of the input gear 30 is meshed with a portion of the internal tooth portion 25A of the output gear 25, the first spur tooth area 30As of the external tooth portion 30A is meshed with the internal tooth portion 25A of the output gear 25 and also a portion of the first tapered tooth area 30At (see FIG. 4) will come into abutment against the outer end portion of the internal tooth portion 25A of the output gear 25 from the direction along the rotational axis X.

In particular, in this meshed state, as shown in FIG. 5, the first spur tooth area 30As of the input gear 30 and the second spur tooth area 25As of the output gear 25 are meshed with each other and simultaneously, the second tapered tooth area 25At of the output gear 25 meshes with the first tapered tooth area 30At of the input gear 30, and also these tooth surfaces are in abutment against each other from the thrust direction.

[Operation Mode of Phase Adjustment Portion]

Though not shown, the phase control motor M (see FIG. 1) is controlled by a control device configured as an ECU (engine control unit).

As shown in FIG. 1, the engine E is equipped with sensors for detecting rotational speeds (numbers of rotations per unit time) and respective rotational phases of the crankshaft 1 and the intake cam shaft 2, and detection signals of these sensors will be inputted to the control device.

The control device maintains a relative rotational phase by driving the phase control motor M at the same speed as the rotational speed of the intake cam shaft 2, at the time of operation of the engine E. In contrast, displacement of the relative rotational phase is realized when the control device effects control of increasing or decreasing the rotational speed of the phase control motor M relative to the rotational speed of the intake cam shaft 2.

In case the phase control motor M is rotated at the same speed as the outer case 11 (same speed as the intake cam shaft 2), no change occurs in the meshing position of the external tooth portion 30A of the input gear 30 relative to the internal tooth portion 25A of the output gear 25, so the relative rotational phase of the driven rotary body B relative to the driving rotary body A is maintained.

In contrast, when the control device drives the output shaft Ma of the phase control motor M at a speed higher than or lower than the rotational speed of the outer case 11, in the phase adjustment portion C, the eccentric axis Y revolves about the rotational axis X. With this revolution, the position of meshing of the external tooth portion 30A of the input gear 30 relative to the internal tooth portion 25A of the output gear 25 will be displaced along the inner circumference of the output gear 25. And, in association with this displacement, a rotational force will act between the input gear 30 and the output gear 25. Namely, a rotational force around the rotational axis X will act on the output gear 25 and a rotational force will act on the input gear 30 which tends to revolve it about the eccentric axis Y.

As described above, the number of teeth of the external tooth portions 30A of the input gear 30 is set 1 (one) fewer than the number of teeth of the internal tooth portions 25A of the output gear 25. Therefore, even in case the eccentric axis Y of the input gear 30 has revolved only one time about the rotational axis X, the output gear 25 will be rotated only by an angle of one tooth relative to the input gear 30, thus realizing power transmission at a high speed reduction ratio.

Further, the input gear 30 does not revolve relative to the outer case 11 since its engagement protrusions 30T engage with the engagement recesses 43a of the internal engagement arms 43 of the coupling member 40, but its rotational force acts on the output gear 25. Due to the action of this rotational force, the intermediate member 20 together with the output gear 25 rotates relative to the outer case 11 about the rotational axis X. As a result, the relative rotational phase between the driving rotary body A and the driven rotary body B is displaced, thus realizing setting of the opening/closing timing by the intake cam shaft 2.

Incidentally, when the eccentric axis Y of the input gear 30 revolves about the rotational axis X, in association with the displacement of the input gear 30, the coupling member 40 of the Oldham's shaft coupling Cx is displaced relative to the outer case 11 in the extending direction (first direction) of the external engagement arms 42 (see FIG. 4), and the input gear 30 is displaced in the extending direction (second direction) of the internal engagement arms 43.

As described above, in the phase adjustment portion C, the first spur tooth area 30As of the input gear 30 meshes with the second spur tooth area 25As of the output gear 25 and the second tapered tooth area 25At of the output gear 25 is placed in abutment against the first tapered tooth area 30At of the input gear 30 from the thrust direction.

Therefore, when even one of the external tooth portion 30A and the internal tooth portion 25A wears, the output gear 25 will be displaced along the rotational axis X in such a manner as to fill the gap created by such wear. Thus, the mutual abutment state between the first tapered tooth area 30At of the input gear 30 and the second tapered tooth area 25At of the output gear 25 in the thrust direction will be maintained, so occurrence of backlash is suppressed. Further, with the above-described arrangement, it is possible to realize improvement of the responsiveness by filling the backlash. Consequently, deterioration of responsiveness due to aging wear can be suppressed also. Furthermore, when torque is to be transmitted between the external tooth portions 30A and the internal tooth portions 25A, against the urging force of the spring 32, the output gear 25 will be displaced slightly in the direction along the rotational axis X, thus realizing smooth operation by creating an appropriate degree of backlash.

### Other Embodiments

The present invention may be embodied alternatively, other than the embodiment described above (components having the same functions as the foregoing embodiment will be denoted with reference numerals and signs common to those used in the foregoing embodiment).

(a) As shown in FIG. 6, a gear transmission device is constituted of an external tooth type driving gear 52 (an example of the “first gear”) rotatably disposed about a first axis P1, an external tooth type driven gear 51 (an example of the “second gear”) rotatably disposed about a second axis P2, and a spring 32 (an example of the “urging portion”).

In this further embodiment (a), the driving gear 52 has a plurality of driving tooth portions 52A and is splined to a drive shaft 54 which is rotatably driven. Further, this driving gear 52 is supported to be shiftable in the direction along the first axis P1 (thrust direction) by an urging force of the spring 32. The driven gear 51 has a plurality of driven tooth portions 51A and is supported to be rotatable in unison with a driven shaft 53 coaxial with a second axis P2.

In each driving tooth portion 52A, there are formed a primary spur tooth area 52As parallel with the first axis P1 and a primary tapered tooth area 52At (another example of the “first tapered tooth area”) having a tooth thickness progressively increased toward one outer end side. Further, in the driven gear 51, there are formed a secondary spur tooth area 51As parallel with the second axis P2 and a secondary tapered tooth area 51At (another example of the “second tapered tooth area”) having a tooth thickness progressively decreased toward the other outer end side.

With the above arrangement, simultaneously with meshing between the primary spur tooth area 52As of the driving gear 52 with the secondary spur tooth area 51As of the driven gear 51, due to the urging force of the spring 32, abutment of the tooth surface of the primary tapered tooth area 52At of the driving tooth portion 52A in the thrust direction relative to the tooth surface of the secondary tapered tooth area 51At of the driven tooth portion 51A is maintained.

And, when even either one of the driving tooth portion 52A of the driving gear 52 and the driven tooth portion 51A of the driven gear 51 wears, the driving gear 52 will be displaced along the first axis P1 in such a manner as to fill the gap created by such wear. And, by this displacement, the mutual abutment state between the tooth surface of the primary tapered tooth area 52At relative to the tooth surface of the secondary tapered tooth area 51At in the thrust direction is maintained to suppress increase of backlash, whereby improvement in the responsiveness is provided and deterioration in the responsiveness due to aging wear is suppressed, thus realizing smooth transmission.

(b) In an arrangement similar to the foregoing embodiment in which the external tooth type input gear 30 and the internal tooth type output gear 25 are provided, conversely from the foregoing embodiment, a tapered tooth area having a tooth thickness progressively decreased toward the inner end side may be formed in the input gear 30 whereas a tapered tooth area having a tooth thickness progressively increased toward the inner end side may be formed in the output gear 25. With this arrangement too, like the arrangement disclosed in the foregoing embodiment, by urging the input gear 30 and the output gear 25 in the thrust direction by the urging force of the spring 32, increase of backlash can be suppressed and responsiveness is improved, and deterioration in the responsiveness due to aging wear can be suppressed.

(c) In the foregoing embodiment, the tapered tooth areas were formed in symmetry relative to the tooth trace direction. Instead of this, the tapered tooth areas may be formed in asymmetry relative to the tooth trace direction or the tapered tooth area may be formed only on one side, centering relative to the tooth trace direction.

Namely, in the case of a gear transmission device configured such that the gears are rotated only in predetermined direction or a large load acts only when the gear is rotated in such predetermined direction, by forming the tapered tooth areas asymmetrically, in correspondence with the rotational direction or the load, suppression of backlash becomes possible. In particularly, in this further embodiment (c), by decreasing the backlash, improvement of the responsiveness is made possible. Thus, deterioration in the responsiveness due to aging wear can be suppressed.

(d) In a further embodiment, on the eccentric bearing face 26E of the eccentric member 26, there is provided a spring (a recess spring) configured to urgingly mesh the external tooth portion 30A of the input gear 30 with the internal tooth portion 25A of the output gear 25. As a specific arrangement thereof, a recess is formed in the eccentric bearing face 26E and a recess spring will be fitted in this recess. And, this recess spring will provide an urging force to displace the input gear 30 in an eccentric direction. With this, the input gear 30 will be placed into a condition constantly subjected to a pressure applied from the recess spring to be displaced in the eccentric direction, so that occurrence of backlash can be suppressed even more favorably.

(e) The gear transmission device may be provided not only for transmitting a driving force, but also for rotationally operating a potentiometer by increasing a rotational amount of a rotary system in order to determine a rotational angle of the rotary system. In the case of this arrangement, with increase of the rotational amount without backlash, detection in high resolution is made possible.

### INDUSTRIAL APPLICABILITY

The present invention is applicable to a gear transmission device configured such that an internal type gear and an external type gear having a fewer teeth than the internal type gear are meshed with each other.

### EXPLANATION OF REFERENCE NUMERALS

25: output gear (second gear)
25A: internal tooth portion (second tooth portion)
25As: second spur tooth area
25At: second tapered tooth area
30: input gear (first gear)
30A: external tooth portion (first tooth portion)
30As: first spur tooth area
30At: first tapered tooth area
32: spring (urging portion)
51: driven gear (second gear)
51A: driven tooth portion (second tooth portion)
51As: secondary spur tooth area
51At: secondary tapered tooth area (second tapered tooth area)
52: driving gear (first gear)
52A: driving tooth portion (first tooth portion)
52As: primary spur tooth area
52At: primary tapered tooth area (first tapered tooth area)
θ: tilt angle

1. A gear transmission device comprising:
a first gear having a plurality of first tooth portions, each of which forms a first tapered tooth area having a spur tooth area on one end side in a tooth width direction and having, on the other side in the tooth width direction, a tooth thickness that increases progressively toward the outer end side;
a second gear disposed coaxially with a second rotational axis parallel with a first rotational axis of the first gear, the second gear having a plurality of second tooth portions, each of which forms a second tapered tooth area having a spur tooth area on one end side in a tooth width direction and having, on the other side in the tooth width direction, a tooth thickness that decreases progressively toward the outer end side; and
an urging portion configured to apply an urging force in a thrust direction to either one of the first gear and the second gear in such a manner that the first tapered tooth area of the first gear and the second tapered tooth area of the second gear come into abutment against each other with the spur tooth area of the second gear meshing with the spur tooth area of the first gear.

2. The gear transmission device of claim 1, wherein at least one of the spur tooth area of the first gear and the spur tooth area of the second gear has a tooth width exceeding a half of the tooth width of each gear.

3. The gear transmission device of claim 1, wherein one of the first gear and the second gear is an internal gear having a plurality of internal tooth portions in an inner circumference of an annular body, and the other thereof is an external gear having a plurality of external tooth portions formed in an outer circumference of a cylindrical body to mesh with the internal tooth portions of the internal gear.

4. The gear transmission device of claim 1, wherein at least one of a tilt angle formed by the tooth surface of the first tapered tooth area relative to the first rotational axis and a tilt angle formed by the tooth surface of the second tapered tooth area relative to the second rotational axis is less than 30 degrees.
